(19) United States
(12) Patent Application Publication
(10) Pub. No.: US 2008/0191170 A1
(43) Pub. Date: Aug. 14, 2008

(54) Use of Ionic Liquids

(75) Inventors: Adam John Walker, Lincolnshire (GB); Erik Richard Gimpel, London (GB); Susan Jane Rosser, Glasgow (GB)

Correspondence Address: POLSINELLI SHALTON FLANIGAN SUELTHAUS PC, 700 W. 47TH STREET, SUITE 1000, KANSAS CITY, MO, 64112-1802, US

(73) Assignee: CAMBRIDGE UNIVERSITY TECHNICAL SERVICES LIMITED, Cambridge, GB (GB)

(21) Appl. No.: 11/576,822

(22) PCT Filed: Oct. 6, 2005
(86) PCT No.: PCT/GB2005/003848

§ 371 Date: Nov. 16, 2007

(30) Foreign Application Priority Data
Oct. 8, 2004 (GB) 0422447.3

(51) Int. Cl. B01F 1/00

(52) U.S. Cl. 252/364

(57) ABSTRACT

This invention relates to the use of ionic liquids. Generally, the ionic liquids are modified during their use so as to change their properties in a manner relevant for that use.

### FIELD OF THE INVENTION

This invention relates to the use of ionic liquids in a wide variety of applications, wherein those ionic liquids are modified during their use so as to change their properties in a manner relevant for that use.

### BACKGROUND OF THE INVENTION

Ionic liquids are compounds which are composed of ions yet are in liquid form, typically having a melting point below ambient temperature. They can be formed by combining suitable acid and base ions, either or both of which are relatively large, charge-delocalised, desymmetrised ions. These types of ion contribute to a reduction in the degree of order of the resulting salt, thus lowering its melting point.

An ionic liquid may be made up of anions and cations, or alternatively (though less commonly) it may consist of zwitterions carrying both a positive and a negative charge on the same molecule.

Ionic liquids can possess a number of remarkable properties, including negligible vapour pressure, high solubilising power and a broad liquid temperature range, which have rendered them interesting alternatives to conventional liquids in a variety of applications. They are known, for instance, to be potentially useful as replacements for organic solvents.

It is well known in the field of chemical synthesis to carry out chemical transformations in liquid reaction media. In particular in the case of multi-step transformations, it is often found that the reaction medium which is most appropriate for one step of the transformation is less appropriate or even entirely inappropriate for another step. This necessitates separation and purification of intermediate products before subsequent reaction steps can be carried out, each such additional processing step increasing the risk of contamination and yield loss.

Also in the field of chemical synthesis it is commonly required to separate reaction products from the medium (typically a liquid) in which they are formed. This also entails significant effort and can often require use of a number of different liquid media, and/or potentially detrimental changes in temperature or pressure, to achieve adequate separation.

Liquid media are also used in a wide variety of applications other than chemical transformations. For instance, liquids can be used as hydraulic fluids, as lubricants, as conductors, as insulators, in electrophoresis and generally as vehicles for other substances in for instance analytical processes or extractions or for storage or transport. In such applications, the chemical and physical properties of the liquid used can be important if not critical. On occasions the properties of a liquid can be acceptable during one stage of its intended use but not during another; to achieve the desired change in properties then entails using a second, different liquid.

The present inventors have devised a system which can overcome or at least mitigate the above described problems.

### STATEMENTS OF THE INVENTION

According to a first aspect of the present invention there is provided the use of an ionic liquid for a predetermined purpose wherein the ionic liquid is chemically modified during that use from a first chemical form to a second chemical form. The physicochemical properties of the second chemical form ionic liquid may then be different from those of the first chemical form ionic liquid; in particular the chemical modification may change properties which are relevant to the predetermined purpose for which the ionic liquid is being used.

In other words, this first aspect of the invention embraces a method involving:
(a) providing an ionic liquid having a first chemical form;
(b) using the first chemical form ionic liquid for a first predetermined purpose;
(c) chemically modifying the first chemical form ionic liquid so as to change it to a second chemical form; and
(d) using the second chemical form ionic liquid for a second predetermined purpose.

The steps (a) to (d) should be carried out in the order specified.

The first and second predetermined purposes may be the same or, more typically, may be different.

The chemical modification of the ionic liquid preferably takes place in situ following its use for the first predetermined purpose. In this context the term “in situ” embraces a situation where the materials (including the first chemical form ionic liquid) need not necessarily remain in the same location, but remain together during the chemical modification step—in other words, the chemical modification does not involve separating the ionic liquid from other (or at least, not from all) species present during its use for the first predetermined purpose. The ionic liquid and other species may be moved to a different physical location, for instance to pass the ionic liquid through an ion exchange column as described below, but they remain together during the chemical modification step so that the modified properties of the second form ionic liquid can then immediately be put to use for the second predetermined purpose. In other words, the bulk system preferably remains the same throughout the modification, or at least no species needs to be removed from the bulk system during the modification.

Such in situ modification provides a convenient alternative to changing a liquid medium, such as a bulk reaction medium, mid-way through a process, thus reducing the number of processing steps and the consequent risks of contamination and yield loss.

In some cases, the ionic liquid and other species present in the system are not moved to a different physical location during, or in order to carry out, the modification.

As mentioned above, the first and second predetermined purposes, for which the ionic liquid is used respectively before and after its chemical modification, may be either the same or different. In this context a “different” purpose includes a purpose which is generically the same as another purpose but requires different physicochemical properties of the ionic liquid. For example, the ionic liquid may be for use as a solvent throughout both stages of its use, but during the second stage it is required to solubilise different entities, and/or to solubilise an entity to a different extent, compared to during the first stage. It may be for use as a lubricant or hydraulic fluid throughout both stages of its use, but during the second stage be required to have a different viscosity and/or surface tension (and hence different visco-elastic and/or dampening properties) to that which is appropriate during the first stage. Preferably the first and second predetermined purposes, though different, are of the same generic type.

Preferably the chemical modification is carried out deliberately by the user in order to facilitate a change in use from the first to the second predetermined purpose. Typically the modification will be necessary in order for the ionic liquid, initially present in its first chemical form, to be used for the second predetermined purpose.

Preferably the modification is separate to, and thus not an inevitable consequence of, the use of the ionic liquid for the first and/or the second predetermined purposes. Thus a modification which occurs to an ionic liquid for example as a consequence of its use as a catalyst would not usually constitute a chemical modification in the context of the present invention. Instead the ionic liquid should be used for a first purpose, subjected to a separate modification step and subsequently used for a second purpose. Either or both of the first and second purposes may involve use of the ionic liquid as a catalyst, but the modification step is not part of that catalytic use although it may have the effect of facilitating such a use.

Ionic liquids have the ability to dissolve a wide range of inorganic, organic, polymeric and biological materials, often to very high concentrations. They have a wide liquid range, allowing both high and low temperature processes to be carried out in the same medium. They do not elicit solvolysis phenomena and most stabilise short-lived reactive intermediates. They have practically zero vapour pressure over much of their liquid range. Ionic liquids can also exhibit excellent electrical and thermal conductivity whilst being non-flammable, recyclable and generally of low toxicity. For all these reasons the present invention is advantageous in that it can facilitate the use of ionic liquids in a wide range of applications.

It is of course known to modify an ionic liquid from a first to a second chemical form during its own production, but the present invention requires that when the modification takes place the ionic liquid has already been provided in a first desired form and is already in use, or has been used, for a first predetermined purpose. Thus the chemical modification does not form part of—indeed it must be subsequent to—the synthesis of the first chemical form ionic liquid. The ionic liquid must be put to two distinct uses, one before and one after the chemical modification step, the modification being necessary or desirable to facilitate the switch from the first to the second use.

Deetlefs et al in Catalysis Today, vol. 72 (2002), pages 29 to 41, disclose the preparation of a thiazolium gold (III) compound which is an ionic liquid having a melting point of around 80° C., and its subsequent use as a catalyst in the hydration of phenylacetylene. They also teach the preparation of a gold (I) carbene complex from an ionic liquid precursor (a 1-butyl-3-methylimidazoliurtm salt). In neither of these cases is an ionic liquid used for one purpose before being chemically modified and then used for a second purpose.

Deetlefs et al also suggest that gold (III)-based ionic liquids might be used as both solvents and catalysts for organic transformations, though they acknowledge that “further work is necessary” and in all of their examples, the catalyst is separate to the reaction medium. They also refer to the possibility of in situ generation of metal complexes and their direct utilisation as catalysts, but again give no examples, and such complexes would of course not necessarily be ionic liquids. Moreover Deetlefs et al make no disclosure of chemically modifying an ionic liquid after it has been put to use as a catalyst, so as to allow it to be put to use for a subsequent second purpose.

In the present invention, modification of the ionic liquid from its first to its second chemical form is preferably such as to alter at least one of its physicochemical properties. The term “physicochemical properties” in this context is intended to embrace both physical and chemical properties. In one embodiment, the chemical modification alters one or more physical properties of the ionic liquid.

The modification is to the chemical form of the ionic liquid. By “chemical form” is meant the chemical molecular structure or composition of the ions of the ionic liquid and/or of their basic lattice unit.

Thus, the first form ionic liquid has a different chemical structure to that of the second form ionic liquid. A chemical modification is therefore not merely (although it may be accompanied by) a physical change such as in the temperature and/or phase of the ionic liquid.

At least one of the first and second chemical forms should be a liquid at the relevant operating temperature, by which is meant the temperature at which the ionic liquid is used for the relevant predetermined purpose. Preferably both chemical forms of the ionic liquid are liquids at their respective operating temperatures.

More preferably, at least one and ideally both of the two chemical forms are capable of existing in liquid form below 60° C., preferably below 50° C., more preferably below 40° C., yet more preferably below 30° C. and ideally at room temperature, which for the present purposes may be defined as from 18 to 25° C., typically about 20° C. An ionic liquid may in cases have a freezing point below 20° C., or even below 15° C. or 10° C.

Preferably the freezing point of at least one, ideally both, of the two chemical forms of the ionic liquid is at least 5° C., more preferably at least 10° C. and most preferably at least 15° C. below the temperature at which it is used.

It is however possible that one of the two chemical forms of the ionic liquid is present as a solid during its use for the relevant predetermined purpose. In this sense, the term “ionic liquid” used in these statements of invention (and the accompanying claims) may in cases embrace an ionic solid.

The boiling point of the ionic liquid is preferably at least 200° C. It may be above 500° C.

An “ionic liquid” must be a compound composed of ions, including a stable stoichiometric hydrate or other solvate of such an ionic material.

The physicochemical property or properties that are modified in the ionic liquid may depend on the purposes for which it is used. Properties which might for example be modified include chemical reactivity; polarity (which can influence miscibility with other fluids and the ability of the ionic liquid to solvate or suspend other chemical entities); dissociation constants (including pKₐ); Lewis or Bronstead acidity and basicity; hydrogen bond accepting and donating ability; electron accepting and donating ability; redox potential; chirality; melting or freezing point; boiling point; viscosity; surface tension; specific heat capacities (at either fixed volume or fixed pressure) or any other thermodynamic property; electromagnetic properties; dielectric constant; colour, or absorbance in any part of the electromagnetic spectrum; refractive index or any other optical property; electrical and/or thermal conductivity; and solvation affinity. Clearly this list is not exhaustive.

In the case where the ionic liquid is used as a carrier medium, properties such as polarity, pKₐ and ability to hydrogen-bond may be particularly important. Where this use involves a chemical reaction, then the reactivity of the ionic liquid may also be important. If the ionic liquid is used as a hydraulic fluid or as a lubricant, viscosity and surface tension may be particularly important. Where it is used as a conductor or insulator or in electrophoresis then electromagnetic properties can be significant. It can be seen that a variety of properties may be relevant in all of the potential uses of the ionic liquid, and one or more of these can be modified during use of the ionic liquid according to the present invention.

Moreover, a change in such a property may be used as an indicator of whether, and/or to what extent, modification of the ionic liquid has been successful.

The modification may result in a change in the melting point of the ionic liquid, which in cases may result—under the relevant operating conditions—in a change in the physical form of the ionic liquid. The modification may, for example, result in solidification of the ionic liquid so as to “capture” a target species in a solid matrix to facilitate its subsequent handling and storage and/or to inhibit a reaction which it might otherwise undergo. Conversely a species captured in an ionic solid may be released into a liquid environment by a modification in accordance with the invention. In these examples the change in physical form may be brought about without the need to alter the temperature and/or pressure of the system.

Chemical modification of the ionic liquid may be deliberately induced by the user to facilitate its use for the second predetermined purpose. However, it is possible that the second (and typically also the first) predetermined purpose is for the ionic liquid to be used as a sensor or indicator, to detect a change in its environment which in turn modifies the first to the second chemical form of the liquid. In such a case it is a change in the environment (which includes any system of which the ionic liquid forms a part, or which is in contact with or can in any way influence the ionic liquid) which induces the modification of the ionic liquid, and a resultant change in properties of the liquid may be used to indicate that the environmental change has occurred.

Indeed, in such a detection system, it is possible that modification of the ionic liquid may in turn influence the detected change in some way, whether directly or indirectly, for instance by modifying the nature and/or rate of the change.

The chemical modification of the ionic liquid can take a number of forms. It may be a modification of the cation and/or the anion of the liquid, or where the liquid is composed of zwitterions, to any part of those ions.

The modification may for instance be, or involve, replacement of the anions and/or the cations. Replacement can be of all relevant ions or only a proportion of them. This can be done by any known means, such as by ion exchange.

For example, the composition of an ionic liquid may be changed by altering the anion associated with a given cation or vice versa. Thus for instance the ionic liquid can be passed through an ion exchange column loaded with the relevant anion or cation so that it is exchanged into the ionic liquid. An example of this would be conversion of an alkyl imidazolium lactate to an alkyl imidazolium hexafluorophosphate. This would typically convert a water-miscible ionic liquid to a water-immiscible one, making it possible (if water were present in the system) to generate two solvent phases from one in situ and thus facilitating extraction and separation procedures.

Alternatively the modification can be, or involve, chemical transformation of all or part of the structure of the ionic liquid. Chemical transformation can be performed directly by chemical reaction (which may be catalysed, by a chemical and/or biochemical catalyst including an enzyme) and/or indirectly using for instance an electric current, electromagnetic radiation, a magnetic field or a change in temperature to induce the transformation.

The fact that for instance chemically induced modifications may be used to alter the physical properties of a liquid medium in situ can have advantages in many applications. Often, for instance where a liquid is used as a hydraulic fluid, it can be desirable to change a physical property of that fluid such as its viscosity, but such changes can only usually be effected by changing the temperature and/or pressure of the system. According to the present invention, the change in physical property can be brought about by much more convenient, and often less invasive, means.

Thus in one embodiment of the invention, the modification of the ionic liquid is effected without, or without substantial, change in the temperature and/or the pressure of the ionic liquid. A “substantial” change in this context may for instance be viewed as a change of 20%, or in cases 10% or even 5%, of the original value.

Suitable chemical modifications include a transformation of a substituent group on one of the ions of the ionic liquid. This might for instance involve the addition or removal of a protecting group. Other chemical modifications may involve for example cleavage of a bond within one of the ions, such as a bond within a ring structure; oxidation, reduction or hydrolysis of an ion or a substituent group; substitution of an associated moiety such as a chelated metal ion; transformation of an amine to an imine; bond and/or substituent rearrangement within an ion; and/or any combination thereof. In general, a chemical modification may involve any change to the arrangement of atoms, ions or radicals within the chemical structure of the ionic liquid, including the cleavage or formation of any covalent, dative or hydrogen bond (in particular a covalent bond).

Where the ionic liquid is used as a solvent for a chemical reaction, a chemically reactive function may be liberated as a result of the modification, allowing the ionic liquid solvent to participate in a subsequent reaction. For instance a hydroxyl group can be released by selective deprotection.

Another possible modification involves the formation or lysis of a polymeric, oligomeric or dimeric ionic liquid. Ionic liquids can exist in polymeric, oligomeric or dimeric forms in which ions are sequentially joined by covalent links such as ester or disulphide bonds. Cleavage of such bonds (for instance by acid hydrolysis or reduction) can lyse the polymer, creating an ionic liquid composed of discrete species. This can affect viscosity and melting point as well as other physical properties—of particular use when the ionic liquid is used as a hydraulic fluid or a lubricant but also potentially affecting its use as a liquid reaction or storage medium.

Conversely, an appropriately functionalised ionic liquid composed of one or more discrete monomer species can be modified so as to create a dimer, oligomer or polymer, with consequent changes in its properties.

The modification may affect the basic lattice unit of the ionic liquid, in particular the nature of any stoichiometric cosolvents present in the lattice. Thus, for example, the modification may involve wholly or partially adding, removing or replacing a cosolvent in the basic lattice unit. This may for example be used to affect properties such as viscosity. The cosolvent may be water or any other suitable solvent.

Specific examples of modifications include those used to alter the solubilising properties of the ionic liquid. For instance, to lower the aqueous solubility, a halide ion may be changed to NTf₂ (bis-trifluoromethylsulphonyl(imide)) or PF₆ (hexafluorophosphate). To lower miscibility with alcohols such as ethanol, a relatively miscible anion such as a carboxylate or halide may be changed to a relatively immiscible one such as a sulphamate, tartrate, EDTA salt or phosphate.

The presence of hydroxyl groups on an ionic liquid—typically on its cations—tends to increase the polarity and hydrophilicity of the liquid and can allow it to act as a hydrogen-bonding solvent. Such hydroxyl groups—and other substituents performing a similar function, for instance nitrile (cyano), carbonyl, nitro or amino groups—can be protected (for instance with a protecting group such as trialkylsilyl) or deprotected to alter the solubilising properties of the ionic liquid.

Ionic liquids which best lend themselves to modification may include those having less stable anions and/or cations, thus facilitating ion exchange, and those having more reactive substituents on their anions and/or cations, thus facilitating chemical modification of those substituents. For example, a sulphate anion can be harder to exchange than other more labile anions such as halides, PF₆ and carboxylates. Typically it can be easier to change an anion than a cation by ion exchange.

Modification of the ionic liquid can involve more than one chemical transformation, but preferably is a one-step transformation.

It may be a reversible, partially reversible or irreversible modification. Preferably it is reversible. During use of the ionic liquid it is even possible that a second chemical modification takes place such that the second chemical form ionic liquid is converted either to a third chemical form ionic liquid or back to the first chemical form.

Preferably the modification to the ionic liquid does not also result in modification of any other chemical species present during its use.

During the modification, generally substantially all of the ionic liquid present during its use for the first predetermined purpose is modified from the first to the second chemical form. In preferred embodiments at least 10 mole %, preferably at least 20 or 30 or 50 mole %, more preferably at least 75 mole %, in particular at least 80 mole % and even at least 90 mole % of the first chemical form ionic liquid is modified to the second chemical form. However in cases it may be preferred for the modification to result in a mixture of two or more different chemical forms of an ionic liquid, so as to enable more fine tuning of the physicochemical properties of the resulting “second chemical form” liquid. The modification may in some cases result in as little as 20% or 10% or even 5% or 3% or 2% of the first chemical form ionic liquid being modified to the second chemical form.

The modification may take place at any speed. In some instances it may be relatively rapid, in which case the ionic liquid might be useable as a sensor, indicator or switch. For example, a rapid change in the refractive index or absorbance of the ionic liquid, for instance light—or electrically induced, could be used in electronics or optoelectronics as an on/off switch—again, the change may be reversible or irreversible depending on its intended purpose (for write-once-read-many data storage devices, for example, an irreversible change would be appropriate).

Slower modifications may be used for example to control the release of a species from the ionic liquid over a period of time—this might have applications for instance in drug delivery. In general the invention can be used to target the release of any species to any desired time or location.

It may be preferred for the ionic liquid, although undergoing modification from a first chemical form to a second chemical form, not to react with other species present during its use, in particular not to react with such species in a way that alters their identity, such as when a covalent bond is cleaved or formed. Thus if the ionic liquid is used as a carrier liquid for a chemical reaction, for example, it may be preferred for the liquid itself not to take part in the reaction. Indirect interactions, such as are involved for instance when a liquid dissolves a solute, including hydrogen bonding and other typically non-covalent associations, may nevertheless still occur between the ionic liquid and species contained within it.

In some cases it may be preferred, where the first predetermined use of the ionic liquid is as a carrier for chemical reactants, for the second predetermined use not to be as a chemical catalyst for those reactants. In other words, it may be preferred for the chemical modification not to convert the ionic liquid from an inert carrier into a chemical catalyst, in particular an organometallic catalyst such as a metal complex. In this context a “chemical catalyst” is one which takes part in a reaction, for instance by forming part of an intermediate species through which the reaction can proceed to completion, in particular involving the anion of the ionic liquid. Preferably, in accordance with the present invention, the ionic liquid is not used as a chemical catalyst which itself takes part in a chemical reaction.

In some cases it may be preferred for the chemical modification not to involve a change in the pH of the system in which the ionic liquid is used.

The modification is preferably not made to another fluid present in the system, in particular to the pH of such a fluid. It is preferably not made to a dissolved or suspended solute present in the system.

The ionic liquid may, during its predetermined uses, be the only bulk liquid present, or it may be present as a mixture (preferably, although not necessarily, single phase) of two or more liquids. It should however be present in the form of an ionic material which is itself in liquid form, as opposed to a solution of an ionic salt (which is not itself liquid under the relevant conditions) in another fluid.

Thus, the ionic liquid may represent any amount of the total fluid present in the system, for example up to 50% or 75% or 90% or 95% of the total amount. In cases it may represent as little as 25% or 20% or 10% or 5% or even 2% of the total amount of fluid present in the system. What is important, in accordance with the invention, is that at least some ionic liquid is present in the system and undergoes a chemical modification, the modification ideally resulting in a change in the system as a whole.

The invention requires the use of at least one ionic liquid that is modified from a first chemical form to a second chemical form. However, mixtures of ionic liquids may be used, in which one or more of the ionic liquids are chemically modified, so that the relevant properties of the overall mixture can be finely tuned. One or more other liquids may be present in the system in addition to the ionic liquid(s) undergoing the chemical modification.

At least one modification is required from a first chemical form to a second chemical form, but the invention also encompasses the carrying out of one or more further such modifications, for instance to third, fourth or even further chemical form ionic liquids, should the circumstances require.

The ionic liquid used in the invention may be made up of anions and cations or it may consist of zwitterions carrying both a positive and a negative charge on the same molecule. Most commonly the ionic liquid will comprise an anion and a cation.

In general the ionic liquid may be any ionic liquid, ie, any ionic material that is a liquid under the relevant conditions.

Preferably, however, the ionic liquid comprises a nitrogen-based cation, more preferably based on a nucleus selected from ammonium cations (suitably secondary, tertiary or quaternary ammonium cations), pyrazolium cations, imidazolium cations, triazolium cations, pyridinium cations, pyridazinium cations, pyrimidinium cations, pyrazinium cations, pyrrolidinium cations and triazinium cations. Alternatively the ionic liquid may comprise a phosphorous-based cation such as a phosphonium ion. Such cations may be substituted at any carbon, nitrogen or phosphorous atom by any (cyclo)alkyl, (cyclo)alkenyl, (cyclo)alkynyl, alkoxy, alkenedioxy, aryl, arylalkyl, aryloxy, amino, aminoalkyl, thio, thioalkyl, hydroxyl, hydroxyalkyl, oxoalkyl, carboxyl, carboxyalkyl, haloalkyl or halogen including all salts, ethers, esters, pentavalent nitrogen or phosphorous derivatives or stereoisomers thereof. When required and where possible, any of these moieties may include a functional group selected from the group consisting of alkenyl, hydroxyl, alkoxy, amino, thio, carbonyl and carboxyl groups.

Particularly preferred ionic liquids are those based on an optionally substituted nucleus selected from ammonium, imidazolium, pyridinium and pyrrolidinium cations.

The ionic liquid may in particular comprise a secondary or tertiary ammonium cation, which is preferably N-substituted with at least one alkanol or alkoxyalkyl (preferably methoxyalkyl) group such as an ethanol, propanol, alkoxyethyl or alkoxypropyl, preferably an ethanol or alkoxyethyl, group. Such cations may additionally be N-substituted by one or two alkyl groups such as C₁ to C₆ alkyl groups, in particular methyl, ethyl or propyl, preferably methyl or ethyl. Thus, preferred ionic liquids may comprise an alkanolammonium (including alkyl alkanolammonium and dialkyl alkanolammonium) cation or a dialkanolammonium (including alkyl dialkanolammonium) cation or an alkoxyalkylammonium (including alkyl alkoxyalkylammonium and dialkyl alkoxyalkylammonium) cation or a di(alkoxyalkyl) ammonium (including alkyl di(alkoxyalkyl) ammonium) cation. In each case, an alkyl or alkoxy group preferably contains from 1 to 4 or from 1 to 3 carbon atoms, and an alkanol group preferably contains from 2 to 4 or from 2 to 3 carbon atoms.

The anion of the ionic liquid may also be of any type. The only theoretical constraint upon the choice of both anion and cation is their combined ionic weight which must be suitable to keep the melting point of the ionic liquid below the desired temperature.

Preferably the anion is selected from halides (for instance fluoride or chloride, in particular chloride); halogenated inorganic anions such as hexafluorophosphate or tetrafluoroborate; halogenated organic anions such as trifluoroacetate; nitrates; sulphates; carbonates; sulphonates and carboxylates. The alkyl groups of the sulphonates and carboxylates may be selected from C₁ to C₂₀, preferably C₁ to C₆, alkyl groups and may be substituted at any position with any alkyl, alkenyl, alkoxy, alkeneoxy, aryl, arylalkyl, aryloxy, amino, aminoalkyl, thio, thioalkyl, hydroxyl, hydroxyalkyl, carbonyl, oxoalkyl, carboxyl, carboxyalkyl or halogen group, including all salts, ethers, esters, pentavalent nitrogen or phosphorous derivatives or stereoisomers thereof.

For example, the anion may be selected from chloride, hexafluorophosphate, tetrafluoroborate, trifluoroacetate, methanesulphonate, glycolate, benzoate, salicylate, (±)-lactate, (+)-lactate, (−)lactate, (+)-pantothenate, (±)-tartrate, (+)-tartrate, (−)-tartrate, (±)-hydrogen tartrate, (+)-hydrogen tartrate, (−)-hydrogen tartrate, (±)-potassium tartrate, (+)-potassium tartrate, (−)-potassium tartrate, meso-tartrate, meso-1-hydrogen tartrate, meso-2-hydrogen tartrate, meso-1-potassium tartrate and meso-2-potassium tartrate.

The ionic liquid used in the invention can be synthesised using known methods. These include methods adapted from the general methods of Koel (see M. Koel, “Physical and chemical properties of ionic liquids based on the dialkylimidazolium cation”, Proc. Estonian Akad. Sci. Chem., 2000, 49 (3), 145-155) and Fuller (see J. Fuller, R. T. Carlin, H. C. de Long and D. Haworth, “Structure of 1-ethyl-3-methylimidazolium hexafluorophosphate: model for room temperature molten salts”, J. Chem. Soc., Them. Comm., 1994, 299-300). For example, equimolar amounts of a heterocyclic amine and the relevant alkyl halide can be refluxed together for an extended period to generate the corresponding halide of the requisite cation. A metal carbonate can be reacted with the acid precursor of the desired anion in order to generate the corresponding metal salt, which can then be dissolved or suspended in water whilst the aforementioned halide is added in aqueous solution. After several hours'stirring, the metal halide (if insoluble) can be removed by filtration and the ionic liquid can be purified (by solvent extraction to remove soluble metal halide if necessary) and dried prior to analysis for instance by ¹H-NMR and UV-VIS/FT-IR spectrophotometry.

Methods of synthesising ionic liquids are also disclosed in “Preparation and characterization of new room temperature ionic liquids”, Luis C. Branco et al, Chem. Eur. J, 2002, 8, 3671-3677 and “Ion conduction in zwitterionic-type molten salts and their polymers”, Yoshizawa et al, J Mater. Chem., 2001, 11, 1057-1062. Any other suitable synthetic methods may be used, for instance those referred to in “Room-temperature ionic liquids, solvents for synthesis and catalysis”, T. Welton, Chemical Reviews, 1999, 99, 2071-2083 (in particular page 2072).

The method of the present invention can have a wide range of applications. For example, the first and/or the second predetermined purpose may be for use as a carrier fluid, in particular a solvent, for one or more other entities. Generally such an entity will interact differently with the two chemical forms of the ionic liquid. The ionic liquid may be a solvent in which an entity is dissolved or it may be a suspending medium in which an entity is suspended but not dissolved. It may be used as a storage or transportation medium for an entity. It may constitute a reaction medium in which at least one chemical transformation takes place. Alternatively, it may be used in an extraction, separation or purification process in which a dissolved or suspended entity is held, perhaps prior to its separation or purification therefrom, but does not undergo any chemical transformation.

Thus according to one embodiment of the invention, the first chemical form ionic liquid may be used as a solvent for a target species to be extracted, for instance an essential oil or other naturally occurring species to be extracted from plant material. Subsequently the ionic liquid is chemically modified, to a second chemical form in which the target species is insoluble or less soluble, thus facilitating the separation and harvesting of the target without the need to use two different liquid media. Alternatively the second chemical form may still act to solubilise the target species, but will no longer dissolve impurities which have been co-extracted with the target, thus facilitating their removal prior to harvesting.

It may also be possible to separate and/or purify a target species from an ionic liquid as solvent if the first chemical form of the ionic liquid is immiscible with a second solvent (for instance water) and the modification to the second chemical form ionic liquid renders the ionic liquid miscible with the second solvent. The modification can then be used to release the target species into the second solvent.

Conversely, where the first chemical form ionic liquid is miscible with a second solvent which is present with the ionic liquid and a target species, modifying the ionic liquid to a second chemical form which is immiscible with the second solvent can be used to generate a two-phase solvent system in which the target species is present in only one of the phases and can therefore be more readily extracted from the mixture.

This type of system can also be used for the removal, for instance by precipitation or phase separation, of impurities, unwanted by-products, excess reactants and any other waste materials. In general terms, then, modification of the ionic liquid may be such as to induce a change in the number of phases present in a mixture, for example inducing precipitation of a solid phase, dissolution of a previously suspended solid, mixing of two previously immiscible fluids and/or separation of a fluid mixture into two or more discrete phases. In turn this may be used to partition a target species between two phases, for instance to allow its separation from one of them.

Such techniques may be used in any purification process in which a target species is desired to be separated from a mixture containing additional species (such as impurities). In a similar manner, the invention may be used to separate two or more species from one another, for instance by adjusting the ability of the ionic liquid to dissolve each of them. Thus the ionic liquid may in general be used as a solvent in any separation, extraction, purification or analogous process.

In particular the invention may be used to extract a target substance (such as an essential oil, or a molecule having medicinal and/or dietetic uses) from plant material, or for example to extract a target substance from wood pulp during paper manufacturing.

In a second embodiment of the invention, the ionic liquid is used as a reaction medium for chemical (which term includes biochemical) reagents. During its use, at least one chemical entity carried in the ionic liquid is chemically transformed—this transformation may occur in either or both of the first and the second chemical forms of the ionic liquid, but typically it will proceed only in one of the chemical forms.

In such cases, modification of the ionic liquid may be used to influence some aspect of the transformation (reaction), for instance its rate (including, at the extremes, whether or not the reaction proceeds at all), its efficiency and/or yield, the balance of any equilibrium involved in the reaction, the stability and/or solubility of any species taking part in or produced by the reaction, and/or the nature of the reaction and its product(s).

For instance, one use according to the invention is of the ionic liquid as a reaction medium in which one chemical transformation takes place in the first chemical form ionic liquid as reaction medium, modification of the ionic liquid takes place during or after this chemical transformation and then a second chemical transformation takes place in the second chemical form ionic liquid as reaction medium. This aspect of the invention can be particularly beneficial for a multi-step chemical transformation where a first reaction step can appropriately be carried out in the first chemical form ionic liquid but the properties of this first chemical form are inadequate or inappropriate—for instance, due to its polarity, solvation capabilities and/or its interaction with one or more of the species present—for carrying out a second reaction step. Ordinarily in such a case, when using conventional organic or aqueous solvents, it would be necessary to remove the intermediate product(s) of the first chemical transformation from the reaction medium and to provide an entirely separate reaction medium for the second chemical transformation. The present invention, however, can remove the need for this step by modifying, in situ, the properties of the reaction medium itself, without the need for intermediate purification and/or removal of any of the species present.

The modification of the ionic liquid may be used to effect a change in the chemical transformation itself, for example to initiate, inhibit or otherwise regulate a reaction step. If necessary the modification may change the ionic liquid from a first chemical form in which it is a suitable solvent for a reaction step, to a second chemical form in which it is less suitable as a solvent for that reaction step, thus allowing the reaction step to be inhibited or even halted at a desired point in time. Conversely the modification may initiate or speed up a reaction step.

The ionic liquid may, as described above, be modified more than once so as to allow more than two steps in a multi-step reaction to proceed in a desired sequence and/or for each step to be carried out in an appropriate reaction medium.

The ionic liquid may thus be used as a carrier for one or more chemical reagents, the reagents being more active in one of the chemical forms of the liquid than in the other. Modifying the ionic liquid may then be used either to induce or to halt a chemical reaction, or otherwise to moderate the time and rate of reaction. Preferably at least one of the reagents is inactive in one of the chemical forms of the ionic liquid, but active in the other. For example such a reagent may be a catalyst, in particular an enzyme, which can be activated or inactivated by modifying the chemical form of its ionic liquid environment.

Modification of the ionic liquid may be used to control a chemical reaction in ways other than by affecting the (re)activity of one or more of the reagents, for example by providing an environment which is either more or less conducive to the reaction taking place.

If the first chemical form ionic liquid is such that the reactants it carries cannot react in it, this can be used to carry and transport the reactants until a time at which reaction is desired. Modification to the second form ionic liquid can then be effected to initiate the reaction. This can be of use when a reaction needs to be carried out at a remote location, such as in a field trial or when using a portable diagnostic test kit. It can be of particular use when the reactants include a biological material such as an enzyme.

Conversely, a chemical transformation may take place in the first chemical form ionic liquid and then, on modification to the second chemical form ionic liquid, the reaction can be terminated and the product potentially stored and kept stable. Again this may be of use in diagnostic test kits, to ensure stability of the test results until a time when analysis can be carried out.

Potentially, the relevant chemical transformation may take place at a different rate or give a different yield in the two different forms of the ionic liquid, again allowing the present invention to be used to influence reaction rates and products.

In a third embodiment, the first chemical form ionic liquid is such as to allow a starting material which it carries to be transformed into a first product, whilst the second chemical form of the ionic liquid is such that the same starting material is transformed into a second, different product. Modification of the ionic liquid can then be used to alter the nature of the reaction taking place at any given time, and thus the natures and yields of the relevant products.

Use of the ionic liquid as a reaction medium in these ways may find application in all manner of chemical syntheses, in particular though not exclusively of pharmaceutical substances and more particularly where biological reagents are involved.

In a fourth embodiment of the invention it may be possible to carry out a chemical reaction in the first chemical form ionic liquid as a reaction medium, and then to modify the ionic liquid to a second chemical form in which one or more of the species present (typically, the desired reaction product, or an impurity or reaction by-product) is no longer soluble. Such a modification may be used to cause the relevant species to precipitate, thus facilitating its removal from the reaction mixture.

Generally speaking, the present invention may be used in this way to facilitate separation, isolation and/or removal of any species which is present in an ionic liquid after another process (typically a chemical reaction or an extraction or separation process) has been carried out in that ionic liquid.

In a fifth embodiment of the invention, the ionic liquid may be used as a fluid in a mechanical, electrical, electronic and/or optical (which may include optoelectronic) process. For instance, it may be used as a hydraulic fluid, as a lubricant, as a conductor, as an insulator, in electrophoresis or in a light transmitting, receiving and/or modifying system (for instance a light filtering or polarising system). It may also be used in lithography techniques as a mask. In general it will be clear to the skilled reader that the ionic liquid may be used in any application in which a liquid environment is needed and for which its properties, both before and after its chemical modification, are suited.

It can thus be seen that the present invention can be widely applicable to uses of ionic liquids in, inter alia, chemical synthesis, industrial chemical reaction and purification processes, environmental remediation and end of pipe reactions.

As described above, according to the invention the first and second predetermined purposes are typically of the same generic type. That is, the first chemical form ionic liquid may be used for the same generic purpose (eg, as a carrier, a mechanical fluid, an electrical fluid, an optical fluid, etc) as is the second chemical form ionic liquid.

Preferred features of the second and subsequent aspects of the invention may be as described in connection with any of the preceding aspects.

Other features of the present invention will become apparent from the following examples. Generally speaking the invention extends to any novel one, or any novel combination, of the features disclosed in this specification (including any accompanying claims). Moreover unless stated otherwise, any feature disclosed herein may be replaced by an alternative feature serving the same or a similar purpose.

### EXAMPLES

### Example 1

### Protecting Group Addition/Removal

The addition/removal of a chemical protecting group from an active functionality within an ionic liquid offers the potential to dramatically and often reversibly alter the physical and chemical properties of the liquid in situ.

For instance, for ionic liquids bearing hydroxylic side-chains (such as on ammonium-based cations), silyl protecting groups may be added or removed to change the liquids' physicochemical properties.

In this example, the ionic liquid used was 3-HOPMIm PF₆(a 3-hydroxypropyl methyl imidazolium cation with a hexafluorophosphate anion).

a) Protection

Dry 3-HOPMIm PF₆(2.86 g, 10 mmol) was placed in a round-bottomed flask and dissolved in 50 ml dry THF. Dry trimethylsilyl (TMS) chloride (1.05 g) was added in dry THF solution, dropwise over a period of 30 minutes, with external cooling and stirring, under an atmosphere of dry argon. Stirring was continued for 12 hours.

At the completion of the reaction (TLC), the solvent was removed in vacuo to yield the silyl-protected ionic liquid (3.52 g, 98%), 3-TMSOPMIm PF₆. This material was a dense, viscous, pale brownish liquid which was effectively immiscible with water.

b) Deprotection

3-TMSOPMIm PF₆(3 g) was added to an aqueous solution of tetraethylammonium fluoride (NEt₄F) (1.5 g in 10 ml) and was shaken at room temperature for 30 minutes. At the conclusion of this period, the initially biphasic mixture had become homogeneous. Removal of water in vacuo yielded a solution of the deprotection products (NEt₄OH and TMSF) in 3-HOPMImPF₆, plus residual NEt₄F.

### Example 2

### Protecting Group Addition/Removal

N,N-diethanolammonium methanesulphonate was protected in the same way as described in Example 1, with the exception that two molar equivalents of the silyl halide were used. The water miscibility of the silylated material was substantially greater than that observed for the mono-protected 3-HOPMIm of Example 1, but much lower than for the unprotected form of the N,N-diethanolammonium methanesulphonate. Viscosity and melting point were also dramatically raised by the protection step; thus in this case the chemical modification (protection/deprotection) might be used to induce a phase change and possibly to enable the trapping or release of a solute between a solid matrix and a liquid solvent medium.

### Example 3

### Ion Exchange to Induce Phase Change

The anion or cation of an ionic liquid can be changed using an ion exchange resin, and the resultant modified ionic liquid may have different physicochemical properties from the unmodified form. Such property changes can occur even if the exchange of ions is only partial.

For example, HOPMIm Cl (hydroxypropyl methyl imidazolium chloride) can be transformed to HOPMIm OH in the presence of Dowex™ 550A OH, as follows.

A solution of HOPMIm Cl (14.5 g) was dissolved in 20.7 g of acetonitrile (MeCN, 41.2%-58.8% by weight). This solution was passed through a column (13.5 cm×2 cm) containing 32 g of DOWEX™ 550A OH resin. The solution recovered was in two phases, the upper being >95% MeCN while the lower containing the ionic liquid carried only 25.3% MeCN (by weight). The product ionic liquid was a mixture of HOPMIm Cl and HOPMIm OH (as determined by the pH change of a 10% solution in water).

It can be seen from this example that a chemical modification such as an ion exchange may be used to create two fluid phases from one. This in turn could be used to partition a species between two phases, in particular to partition a solute between two different liquid phases.

### Example 4

### Ion Exchange to Alter Viscosity & Refractive Index

A method similar to that of Example 3 was used to convert the ionic liquid n-butyl diethanolammonium trifluoroacetate to the corresponding acetate, using an ion exchange resin. The effects of the conversion on the refractive index and viscosity of the ionic liquid were observed.

Refractive index was measured using a Mettler Toledo Refracto™ 30PX, using a single wavelength light source (the sodium D-line at 589.3 nm). Viscosity was measured using an AND Vibro™ SV10 instrument, which measures viscosity by controlling the amplitude of vibrations of sensor plates submerged in a liquid, detecting changes in the electric current needed to drive the plates.

The n-butyl diethanolammonium trifluoroacetate starting material had a refractive index of 1.434 and a viscosity of 440 mPa.s at 25° C.

To prepare the ion exchange resin, ˜50 ml of Dowex™ 550A OH anion exchange resin was added to ˜25 ml of acetic acid (conc.). This was left to equilibrate at 25° C. for 30 minutes with regular stirring. The acid was then removed by filtration and the ion exchange beads were washed three times with ethanol and dried by vacuum filtration.

10 ml of the n-butyl diethanolammonium trifluoroacetate was heated to ˜50° C. in a beaker and ˜25 g of the prepared Dowex™ acetate was added such that the beads were completely submersed in the ionic liquid. The mixture was left to equilibrate at 30° C. for ˜1 hour, with regular shaking/stirring. A sample of the thus modified ionic liquid was recovered by vacuum filtration and rotary evaporation to remove residual ethanol.

The modified ionic liquid was found to have a refractive index of 1.447 and a viscosity of ˜280 mPa.s at 25° C. By comparison with the properties of pure n-butyl diethanolammonium acetate (refractive index 1.464; viscosity ˜285 mPa.s at 25° C.), this indicated that the starting material had been almost fully converted to the corresponding acetate.

Table 1 summarises these results.

TABLE 1

| | | Viscosity |
|---|---|---|
| Sample | Refractive index | (mPa · s at 25° C.) |
| Pure n-butyl | 1.434 | 440 |
| diethanolammonium | | |
| trifluoroacetate | | |
| In situ modified | 1.447 | 280 |
| sample | | |
| Pure n-butyl | 1.464 | 285 |
| diethanolammonium | | |
| acetate | | |

It can be seen that the ion exchange process can be used to modify, inter alia, the refractive index and viscosity of an ionic liquid. The extent to which the ion exchange is completed can influence the properties obtained; hence the degree of chemical modification to an ionic liquid can be used to tailor the physicochemical properties of its modified form.

Changes such as these may be of use in all manner of applications. A change in viscosity may for example be of value when an ionic liquid is used as a hydraulic fluid or a lubricant, a change in refractive index when an ionic liquid is used in optoelectronic systems. Such changes can be brought about chemically, without the need to alter for instance the temperature or pressure of a system.

### Example 5

### Ion Exchange to Alter Solubilising Power

In this example, the ionic liquid dimethyl ethanolammonium trifluoroacetate was converted by ion exchange to dimethyl ethanolammonium crotonate, to assess the effect of the modification on the ability of the ionic liquid to act as a solvent for penicillin G (sodium salt).

To crotonic acid (10.0 g) in ˜50 ml of ethanol, 40.3 g of Dowex™ 550A OH anion exchange resin was added. The mixture was left to equilibrate at room temperature for ˜30 minutes, with regular shaking. It was then washed three times with ethanol and dried by vacuum filtration.

To the thus prepared Dowex™ crotonate beads (˜25 g), 16 ml of a solution of penicillin G (sodium salt) in dimethyl ethanolammonium trifluoroacetate/ethanol (25/75 v/v) was added. The penicillin concentration in this solution was 60 mg/ml. Ethanol was used partly to reduce the viscosity of the solution and hence speed up the process, and partly to help accommodate the ion exchange beads since the experiment was conducted at beaker scale. The experiment would also have worked using less ethanol or even using pure dimethyl ethanolammonium trifluoroacetate as the solvent.

The Dowex™/ionic liquid/ethanol/penicillin mixture was stirred at room temperature. Penicillin began to precipitate within seconds.

The solubility of penicillin G (sodium salt) in pure dimethyl ethanolammonium trifluoroacetate is >275 mg/ml. In dimethyl ethanolammonium trifluoroacetate/ethanol (25/75 v/v) its solubility is 76 mg/ml (ie, readily soluble).

The solubility of the antibiotic in pure dimethyl ethanolammonium crotonate is however only ˜20 mg/ml, and in dimethyl ethanolammonium crotonate/ethanol (25/75 v/v) its solubility was found to be ˜50 mg/ml. Thus modification of the ionic liquid component of the solvent, from the trifluoroacetate to the crotonate, significantly altered the solubility of the antibiotic, leading ultimately to its precipitation.

In this way the method of the present invention may be used selectively to precipitate target species (for example, either reaction products or undesired impurities) from mixtures of species, and in turn may assist in the harvesting of reaction products or extracted materials.

### Example 6

### Effect of Modification on Enzyme Activity

Chemical modification of an ionic liquid, in accordance with the present invention, may be used to modify the activity of a species held in the liquid, and thus to regulate the nature and/or rate of a reaction being carried out in the liquid.

The activities of the cofactor-dependent enzyme morphine dehydrogenase (MDH) in a range of ionic liquids are shown in Table 2 (source: Walker & Bruce, Chem. Commun., 2004, 2570-2571). The reaction concerned was the oxidation of codeine to codeinone, using glucose dehydrogenase from Cryptococcus uniguttulatus to recycle the NADP+ cofactor; it was carried out in the presence of <100 ppm water. The morphine dehydrogenase was obtained from Pseudomonas putida M10.

TABLE 2

| | Net % | | |
|---|---|---|---|
| | codeinone | | |
| Ionic liquid | 1 hour | 4 hours | 24 hours |
| BMIm PF₆ | 0 | 0 | 2 |
| BMIm glycolate | 0 | 5 | 12 |
| HOPMIm PF₆ | 2 | 9 | 20 |
| HOPMIm glycolate | small | 5 | 16 |
| HOPMIm Cl | 0 | 0 | Small |

(BMIm = 1-butyl-3-methylimidazolium; HOPMIm = hydroxypropyl-3-methyl imidazolium; PF₆ = hexafluorophosphate)

It can be seen from Table 2 that by modifying the anion on an ionic liquid solvent, for instance by ion exchange as described in the examples above, a significant change can be achieved in the activity of an enzyme carried in the ionic liquid. This in turn can be used to regulate the progress of an enzyme-catalysed reaction occurring in the liquid, for instance by initiating the reaction at a desired time and/or location, halting the reaction when necessary, and/or modifying the reaction rate according to requirements.

For example, in BMIm PF₆, MDH activity is extremely low; water would be essential for a reaction to proceed. Activity is however greatly improved in the hydrogen bonding BMIm glycolate. Thus modification between the PF₆ and the glycolate anion (for instance by ion exchange) could be used effectively as an on/off switch for a MDH-catalysed reaction.

In the case of the HOPMIm salts, the reaction rate may be modified by altering the anion present, the chloride allowing very little activity, the glycolate a moderate level of activity and the hexafluorophosphate a high level.

1. A method of using an ionic liquid, the method comprising, in the order specified:
(a) providing an ionic liquid having a first chemical form;
(b) using the first chemical form ionic liquid for a first predetermined purpose;
(c) chemically modifying the first chemical form ionic liquid so as to change it to a second chemical form; and
(d) using the second chemical form ionic liquid for a second predetermined purpose.

2. The method according to claim 1, wherein the first and second predetermined purposes are different.

3. (canceled)

4. The method according to claim 1, wherein the first the second, or both the first and the second predetermined purpose involves using the ionic liquid as a carrier for one or more species.

5. (canceled)

6. The method according to claim 4 wherein the first, the second, or both the first and the second predetermined purpose involves using the ionic liquid as a reaction medium.

7-8. (canceled)

9. The method according to claim 6, wherein modification of the ionic liquid alters at least one property of a reaction occurring or about to occur in it.

10. The method according to claim 9, wherein modification of the ionic liquid alters the rate of a reaction occurring or about to occur in it.

11. The method according to claim 10, wherein the reaction proceeds in only one out of the first and second chemical forms of the ionic liquid.

12. (canceled)

13. The method according to claim 6, wherein a first reaction is carried out in the first chemical form ionic liquid and a second, different, reaction is subsequently carried out in the second chemical form ionic liquid.

14. The method according to claim 4 or claim 6, wherein modification of the ionic liquid alters its ability to solubilise one or more of the species it carries.

15-16. (canceled)

17. The method according to claim 4 or claim 6, wherein modification of the ionic liquid results in a phase separation between the ionic liquid and a species it carries.

18. The method according to any one of the preceding claims, wherein the first, the second, or both the first and the second predetermined purpose involves using of the ionic liquid in a mechanical process, as a hydraulic fluid, as a lubricant, in an electrical process, as an electrical conductor or insulator, in electrophoresis, as a thermal conductor or insulator, or in an optical process.

19-25. (canceled)

26. The method according to claim 1, wherein at least the second predetermined purpose involves using the ionic liquid as a sensor or indicator, to detect a change in its environment, which change modifies the ionic liquid from its first to its second chemical form.

27-28. (canceled)

29. The method according to claim 1, wherein both the first and the second chemical forms of the ionic liquid are in liquid form at their respective operating temperatures.

30-31. (canceled)

32. The method according to claim 1, wherein both the first and the second chemical forms of the ionic liquid are capable of existing in liquid form at a relevant temperature.

33. The method according to claim 1, wherein modification of the ionic liquid alters at least one of its physicochemical properties.

34. The method according to claim 33, wherein modification of the ionic liquid alters a property selected from the group consisting of chemical reactivity; polarity; dissociation constants; Lewis or Bronstead acidity and basicity; hydrogen bond accepting and donating ability; electron accepting and donating ability; redox potential; chirality; melting or freezing point; boiling point; viscosity; surface tension; specific heat capacity and other thermodynamic properties; electromagnetic properties; dielectric constant; absorbance in any part of the electromagnetic spectrum; refractive index and other optical properties; electrical and thermal conductivity; solvation affinity; and combinations thereof.

35-39. (canceled)

40. The method according to claim 34, wherein modification of the ionic liquid alters its miscibility with another fluid which is present during its first, second, or both first and second predetermined use.

41-42. (canceled)

43. The method according to claim 1, wherein modification of the ionic liquid results in a change in its physical form.

44. (canceled)

45. The method according to claim 1, wherein modification of the ionic liquid involves replacement of at least a proportion of its anions, cations, or both anions and cations.

46. The method according to claim 45, wherein modification of the ionic liquid involves replacement of at least a proportion of its anions.

47. The method according to claim 1, wherein modification of the ionic liquid involves chemical transformation of at least a part of the structure of the ionic liquid.

48. The method according to claim 47, wherein the chemical transformation is performed directly by chemical reaction.

49. The method according to claim 47, wherein the chemical transformation is induced by non-chemical means.

50. The method according to claim 47, wherein the chemical transformation involves transformation of a substituent group on one of the ions of the ionic liquid.

51. The method according to claim 47, wherein the chemical transformation involves the addition or removal of a protecting group.

52. The method according to claim 47, wherein the chemical transformation involves cleavage or formation of a bond within one of the ions of the ionic liquid.

53. The method according to claim 47, wherein the chemical transformation involves the formation or lysis of a polymeric, oligomeric or dimeric ionic liquid.

54. The method according to laim 1, wherein modification of the ionic liquid involves wholly or partially adding, removing or replacing a cosolvent in the basic lattice unit of the ionic liquid.

55. The method according to claim 1, wherein modification of the ionic liquid is effected without substantial change in its temperature, pressure, or both temperature and pressure.

56. The method according to claim 1, wherein modification of the ionic liquid is a one-step transformation.

57-58. (canceled)

59. The method according to claim 1, wherein during modification of the ionic liquid, at least 25 mole % of the first chemical form ionic liquid is changed to the second chemical form.

60-66. (canceled)

67. The method according to claim 1, wherein modification of the ionic liquid is used to control the release of a species from the ionic liquid over a period of time, or to target its release to a desired time or location.

68. The method according to claim 1, wherein modification of the ionic liquid is used to separate a target species from other species present in a mixture.

69. The method according to claim 1, wherein modification of the ionic liquid induces a change in the number of phases present in a mixture.

70. The method according to claim 1, wherein modification of the ionic liquid takes place in situ following its use for the first predetermined purpose.

71. (canceled)
